(19) United States
(12) Patent Application Publication
(10) Pub. No.: US 2017/0140101 A1
(43) Pub. Date: May 18, 2017

(54) PORTABLE HEALTH RECORD SYSTEM AND METHOD

(71) Applicants: Kyle L. Anderson, Mesa, AZ (US); Mark H. Connor, Phoenix, AZ (US)

(72) Inventors: Kyle L. Anderson, Mesa, AZ (US); Mark H. Connor, Phoenix, AZ (US)

(21) Appl. No.: 15/269,807

(22) Filed: Sep. 19, 2016

Related U.S. Application Data
(60) Provisional application No. 62/221,012, filed on Sep. 19, 2015.
(60) Provisional application No. 62/279,146, filed on Jan. 15, 2016.

(51) Int. Cl. G06F 19/00

(52) U.S. Cl. CPC G06F 19/322; G06F 19/3418

(57) ABSTRACT

Systems and methods of creating, accessing, storing, and editing an individual's personal health information are provided. The health record or data for the user can be shared with medical or health personnel, while enabling the user or patient to keep it on their person at all times. Further, the user or patient can control the level and details of the information made available to such other persons or organizations.

### PRIORITY

This Application claims priority to and the benefit of U.S. Provisional Patent Application No. 62/221,012, filed Sep. 19, 2015, and U.S. Provisional Patent Application No. 62/279,146, filed Jan. 15, 2016; with both of the identified applications and disclosures incorporated fully herein by reference.

### TECHNICAL FIELD

The present invention relates generally to medical information and storage systems and, more particularly, to systems and methods of accessing, storing, and editing one's own personal health information, and sharing that information with medical personnel.

### BACKGROUND OF THE INVENTION

While medical information on a patient can be key to properly diagnosing and treating injuries and diseases, there are often situations where a patient's medical records are not readily available. For instance, in an emergency, patients have often suffered trauma, or are even unconscious or unresponsive. These are the times when medical information is likely most urgent and needed.

In addition, patients often don't remember all of the details of their own medical history and may not be able to recite important medical facts to the treating medical professional in a timely or accurate manner. This can cause unwanted delay or even initiate dangerous treatment plans—e.g., actions taken based on unknown allergies, past procedures or surgeries, unknown medications, disorders or diseases, and the like.

Emergency department physicians have been asked what information they find to be the most critical when a complex patient presents to the emergency room (“ER”). Here is the information the physicians identified as most important: 12.5% medications; 10.4% past medical history; 12.5% allergies; 2.0% social history; with approximately 60% identifying all of the above information as important considerations.

It has been estimated that 98,000 Americans die each year as a result of preventable medical errors. Many medical providers attribute medical errors to not having the proper health information when it is crucial. Some data shows that more than 80% of people ages 57 and up take at least one medication daily, and 60% of patients cannot identify their own medications. It is also estimated that 5.1 million people in the US have Alzheimers and are unable to effectively communicate their personal health information.

Astonishingly, it has been estimated that there are 125 million chronically ill people of all ages in the United States—over 42% of the US population. It is estimated that there will be 157 million chronically ill people by the year 2020.

Patients who received enhanced decision-making support ultimately had overall medical costs that were 5.3 percent lower than for those receiving only the usual support. They also had 12.5 percent fewer hospital admissions.

As such, improved personal health records systems and methods are needed to reduce medical errors, improve diagnosis and treatment goals, and ultimately lower the cost of care while also increasing patient satisfaction.

### SUMMARY OF THE INVENTION

Particular embodiments of the present invention are directed to accessing, storing, and editing an individual's personal health information, as well as sharing it with medical personnel, while enabling the user or patient to keep it on their person at all times. In certain instances of the invention, this health information is referred to as “PHR+”—portable health record. The PHR+ will provide medical personnel with up-to-date health information in both emergency and non-emergency situations. Further, the user or patient can control the level of information made available to such medical personnel, and others.

The present invention is designed in various embodiments to process and compile a user's personal health information from outside databases, which is then processed and parsed down into an easy to use portable personal health record. The system of the present invention will be able to upload information from a CCD, HL7, XML, API interfaces, and other types of files. The PHR+ personal health record can also interface with patient portals of clinics, labs, and other health services or systems. A user can search for clinic, lab, or health system/services, selecting their facility, and then authenticating PHR+ to facilitate uploading of the user's data from the patient portal—e.g., by providing the Username and Password for the facility. The system of the present invention can process screen scraping software technologies to parse important medical information from various electronic data sources, including the user, the health care provider, or the health system's patient portal.

The user's medical information is then uploaded (e.g., medications, medical conditions, allergies, immunizations, and other relevant information) onto the PHR+ personal health record software and/or database of the health care provider or system. The user can access their personal health record to view, make information private, add information, and edit the information via a user device (USB device, wearable, desktop computer, laptop computer, mobile device, etc.) with software pre-loaded on the respective device, a mobile application, a web application, or the like.

The system of the present invention can automatically sync data from third party medical devices (e.g., glucometers, blood pressure monitors, SPO2 sensors, thermometers, etc.), activity trackers (e.g., Fitbit, Jawbone, iHealth, etc.), and health related applications (e.g., Runkeeper, MapMyFitness, Apple Activity, MyFitnessPal, etc.) via various platforms and interfaces, including application specific APIs, wired or wireless connectivity (e.g., Wi-Fi, Bluetooth, etc.). This data is synchronized to a user's personal health record upon their authorization. A user can select a device or application that they want to sync to PHR+, and then input their username and password to the PHR+ application for the corresponding third party manufacturer's web app, mobile app, and the like. Data is then displayed within the user's dashboard to give them an accurate insight, summary, and details on their medical data and conditions. The user has the ability to add or link as many devices and fitness apps as they choose via simple configuration and input from the user within the PHR+ dashboard. Further, the user can selectively disassociate a device from their personal health record dashboard.

Users can view their corresponding dashboard data via a web application, mobile applications, USB application, and like system interfaces. Additionally, the data on the devices can be displayed or retrieved via a public profile on a USB device, by scanning RFID or NFC devices or components, or via the scanning of QR codes. The user has the ability to decide and select, within privacy settings of the system, what devices, apps, or personal health information is viewable in the public profile and what information is password protected and private. The user can also selectively elect and input which specific data they want to share with others, as public or private information.

The system can further include a physical and electronically readable card in various configurations and formats. The card can include the user's profile picture, contact information, emergency contact information, medical alert information, and like data. Each card can include a unique ID#, unique PIN#, and QR code printed or otherwise provided on the card. In addition, the card can include an RFID or NFC tag or device embedded or otherwise provided therewith—the tag can have a unique value assigned and associated to that particular card. Access to a user's public information can be conducted via any device by scanning the unique QR code on the user's card, scanning the unique RFID/NFC tag, via a web application, via biometric authentication on a device (e.g., on a smartphone, laptop, or tablet), via inputting of a user PIN and ID number, via an application that automatically launches a URL with the user's PIN & ID number, and a myriad of other security, login, and data reading methods and techniques.

When a user adds information, e.g., via device inputs, on any of their PHR+ registered devices, all of the user's other PHR+ registered devices will synchronize and update accordingly. For example, if a user updates their PHR+ personal health record using a USB bracelet, their PHR+ mobile app will synchronize to reflect the inputted changes.

Again, the PHR+ software will allow the user to decide what information from their personal health record is public, and what information is private. For example, if a user wants one of their medical conditions to be “marked private” the user will make an input selection (e.g., menu option or input select) and that information will not be visible or displayed via their personal health record unless the user's password, or like authentication, has been entered or received—which the user can give to medical or other personnel at their own discretion.

Base methods and means of accessing the information on the user's medical device can include at least the following: RFID or NFC chip scan, QR code scan, plugging in a USB device, and other wired or wireless communication methods and techniques, such that corresponding software is automatically opened on one or more devices. In certain embodiments, only the user's “public profile” is displayed if proper authentication is not received or inputted (e.g., entering a password). This public profile and its associated medical information can be used by medical personnel or first responders to provide a more accurate and viable treatment or diagnosis.

In embodiments of the present invention, the PHR+ software can be viewed on any computing device, requires no internet access, and medical staff is not required to download any software to view this medical information. All necessary data and software code can be contained or stored on the user device—whether automatically displayed on a medical professional's device or viewed from the user device itself (e.g., smartwatch, smartphone, wearable, etc.). Accordingly, the best and most detailed information can be presented to the medical professional at the point of care, and instantly. This in turn provides patient empowerment, improved quality of care, patient loyalty, improved continuity of care, and a reduction in healthcare costs.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 shows an exemplary user device, in accordance with embodiments of the present invention.

FIG. 2 shows elements of a system for inputting/editing a user device with personal health record data, in accordance with embodiments of the present invention.

FIG. 3 shows a user device in operable communication with a centralized personal health record system, in accordance with embodiments of the present invention.

FIG. 4 shows a plurality of user devices in operable communication with a centralized personal health record system, and accordingly in operable communication with a plurality of health care entities, in accordance with embodiments of the present invention.

FIGS. 5-7 show readable ID card devices, in accordance with embodiments of the present invention.

FIG. 8 shows a system diagram of a portable health record system and method, in accordance with embodiments of the present invention.

FIG. 9 shows a flow chart of a USB device registration and interface method, in accordance with embodiments of the present invention.

FIG. 10 shows a flow chart of user registration for a portable health record system and method, in accordance with embodiments of the present invention.

FIG. 11 shows a flow diagram of web-based registration and access to a portable health record system and method, in accordance with embodiments of the present invention.

FIG. 12 shows a flow diagram of registration and access to a portable health record system and method via a USB or like device, in accordance with embodiments of the present invention.

FIG. 13 shows a flow diagram of registration and access to a portable health record system and method via a smartphone or like mobile device, in accordance with embodiments of the present invention.

FIG. 14 shows a flow diagram of an RFID scanning system and method to determine and/or obtain the personal health record of a patient, in accordance with embodiments of the present invention.

FIG. 15 shows a flow diagram of a QR code scanning system and method to determine and/or obtain the personal health record of a patient, in accordance with embodiments of the present invention.

FIG. 16 shows a flow diagram of an NFC scanning system and method to determine and/or obtain the personal health record of a patient, in accordance with embodiments of the present invention.

FIG. 17 shows a flow diagram of a system and method of user and medical professional access to a personal health record database, in accordance with embodiments of the present invention.

FIG. 18 shows a registration software screenshot, wherein the software is adapted to receive inputted data and to display information at designated fields, in accordance with embodiments of the present invention.

FIG. 19 shows a patient “basic information” software screenshot, wherein the software is adapted to receive inputted data and to display information at designated fields, in accordance with embodiments of the present invention.

FIG. 20 shows a patient profile summary software screenshot, wherein the software is adapted to receive inputted data and to display information at designated fields, in accordance with embodiments of the present invention.

FIG. 21 shows a “family history” software screenshot, wherein the software is adapted to receive inputted data and to display information at designated fields, in accordance with embodiments of the present invention.

FIG. 22 shows a “medical condition” software screenshot, wherein the software is adapted to receive inputted data and to display information at designated fields, in accordance with embodiments of the present invention.

FIG. 23 shows a “social history” software screenshot, wherein the software is adapted to receive inputted data and to display information at designated fields, in accordance with embodiments of the present invention.

FIG. 24 shows a mobile app software screenshot, wherein the software is adapted to receive inputted data and to display information at designated fields, in accordance with embodiments of the present invention.

FIG. 25 shows a patient engagement software screenshot, wherein the software is adapted to receive inputted data and to display information at designated fields, in accordance with embodiments of the present invention.

FIG. 26 shows a medical/healthcare provider interface software screenshot, wherein the software is adapted to receive inputted data and to display information at designated fields, in accordance with embodiments of the present invention.

FIG. 27 shows a patient list software screenshot for the medical/healthcare provider, wherein the software is adapted to receive inputted data and to display information at designated fields, in accordance with embodiments of the present invention.

FIG. 28 shows a patient engagement software screenshot, wherein the software is adapted to receive inputted data and to display information at designated fields, in accordance with embodiments of the present invention.

FIG. 29 shows patient medical summary software screenshot, wherein the software is adapted to receive inputted data and to display information at designated fields, in accordance with embodiments of the present invention.

FIG. 30 shows a patient population software screenshot for a medical condition, wherein the software is adapted to receive inputted data and to display information at designated fields, in accordance with embodiments of the present invention.

### DETAILED DESCRIPTION

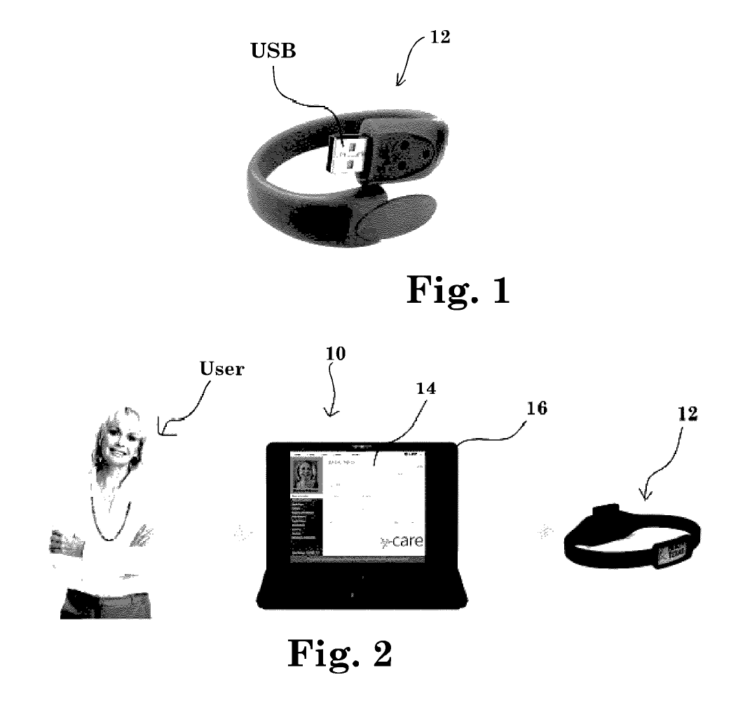

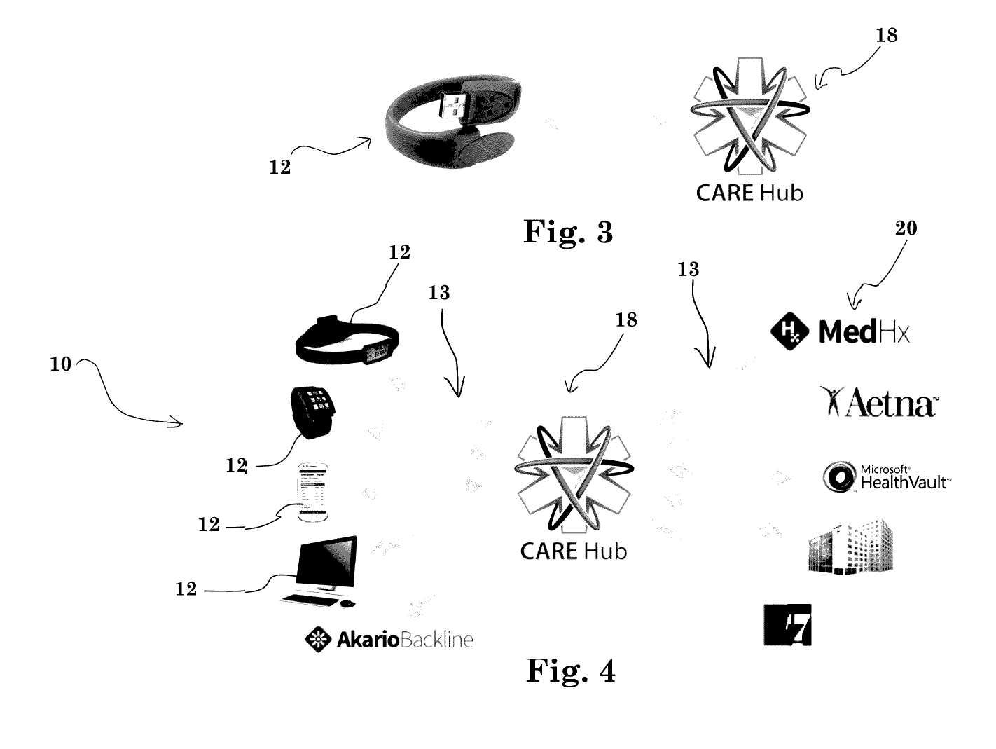

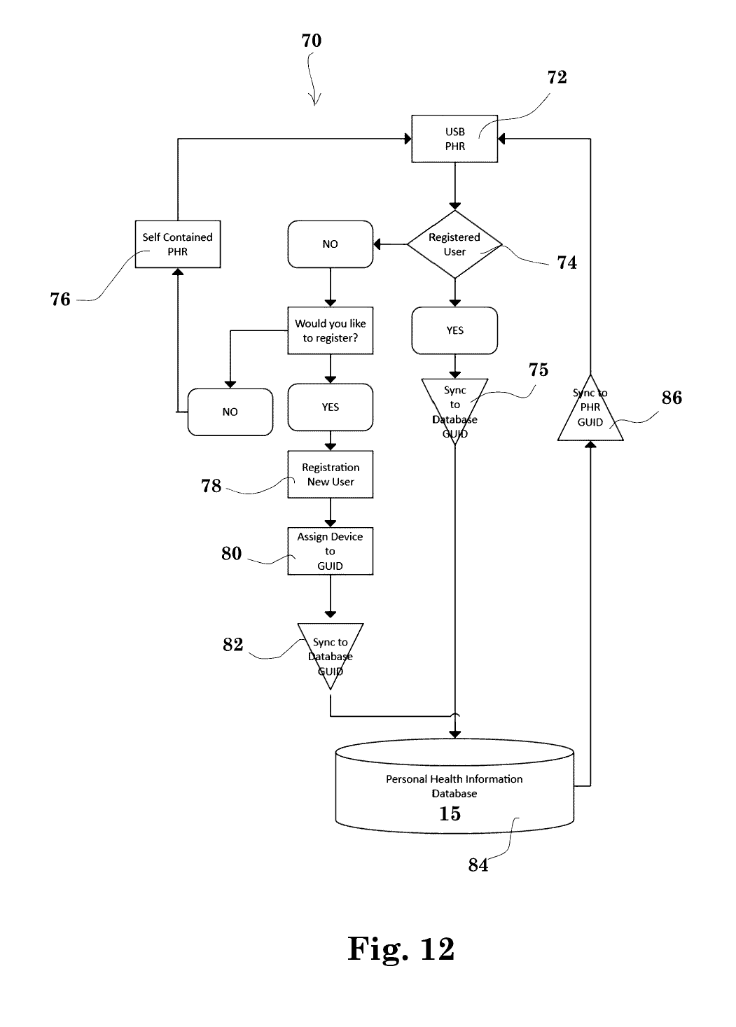

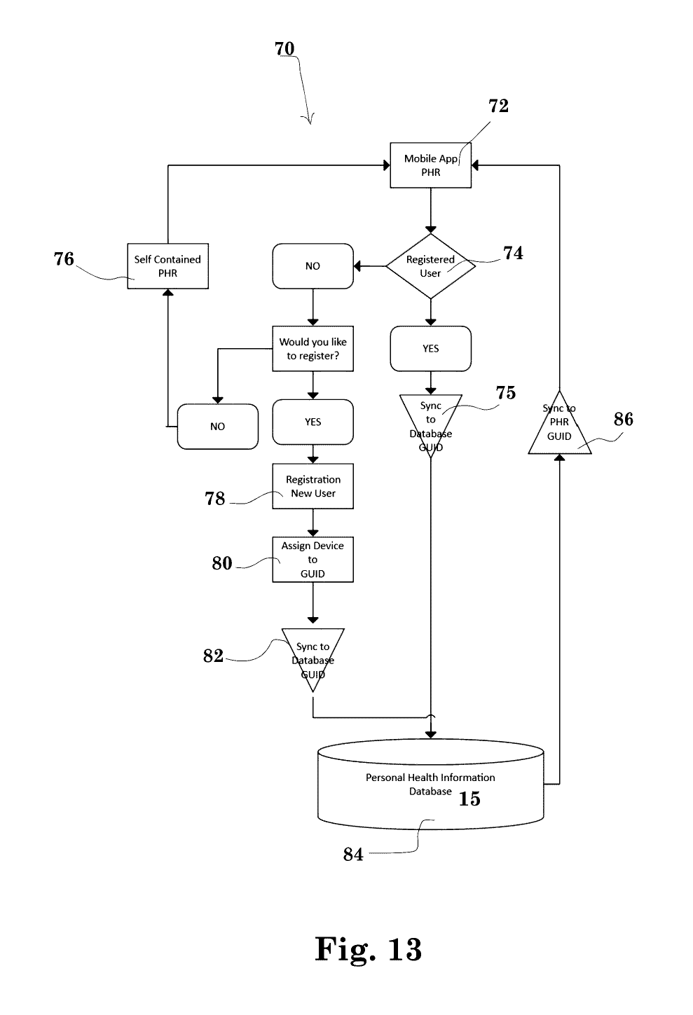

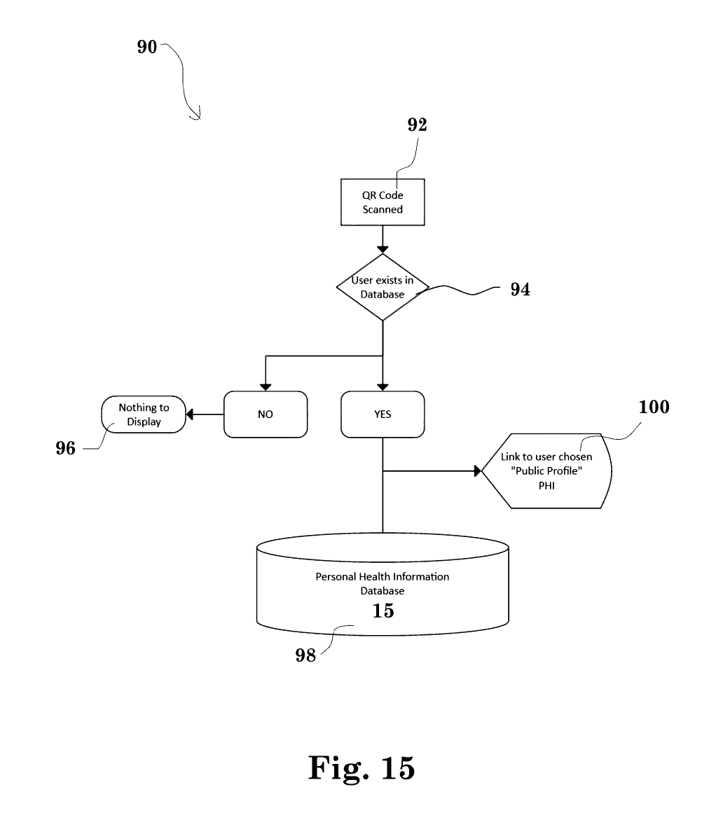

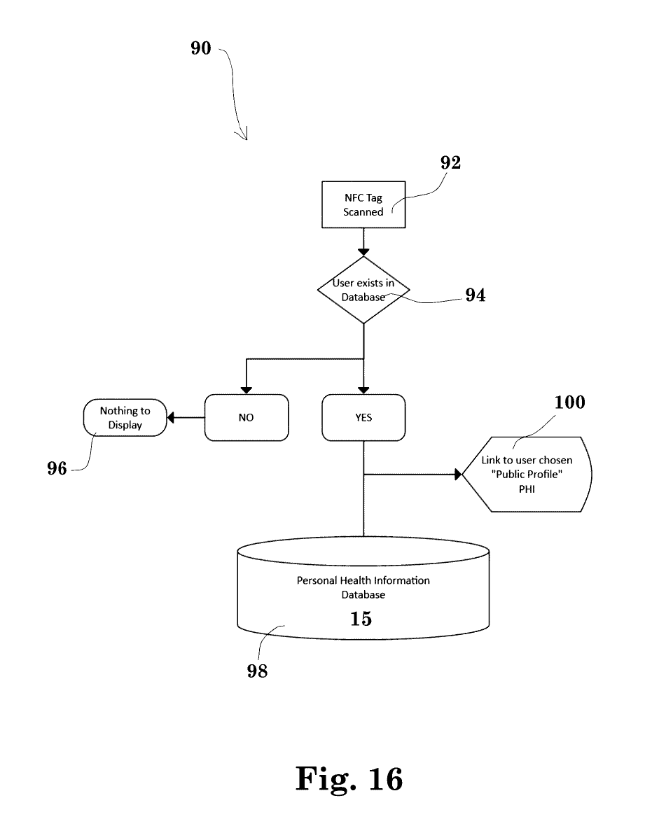

Referring generally to FIGS. 1-30, exemplary systems, methods, and computer program products for inputting, maintaining, storing, and displaying personal health records and information are provided. The system 10 can include a user device 12 and health record maintenance software 14. Use of the terms PHR, PHR+, or a personal health information database can reference a database and software system 15 for writing to, storing, editing, and retrieving a user's personal health data.

Referring now to FIGS. 1-4, exemplary systems 10 and user devices 12 are depicted. The user devices 12 can include a USB device, a wearable device, a smartphone or mobile device, an ID card or element, a desktop or laptop computer, and the like. Each user device 12 can include memory, such as non-transitive, which may include one or more non-volatile storage devices and/or one or more volatile storage devices (e.g., random access memory (RAM)). With certain embodiments, the device 12 can include a microprocessor. Computer readable program code may be stored in a computer readable medium or memory, and configured to execute the health record maintenance software 14.

Various embodiments of the present invention can include standalone personal health records created and maintained by the end user or patient, which are not interconnected to a centralized data hub 18 or database 15, or other health care entities 20. If this is the case, then the personal health data for the user is simply maintained on the user device 12 and made available for use by medical professionals as needed. In other embodiments, as illustrated in FIG. 4, the personal health records for an individual user can be operably updated and synchronized via a central data hub 18 and server database 15. User devices 12 and health care entities 20 can communicate with the server hub 18 and database 15 via a network 13—e.g., the internet—as authorized by the end user.

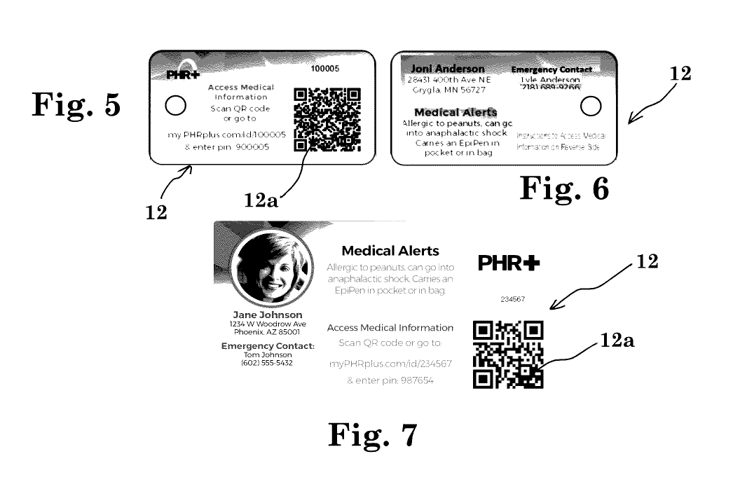

The electronically readable ID card 12 can include the user's profile picture, contact information, emergency contact information, medical alert information, and like data, as shown in FIGS. 5-7. Each card can include a unique ID#, a unique PIN#, URL, and a QR code 12a printed or otherwise provided on the card. In addition, the card can include an RFID or NFC tag or device embedded or otherwise provided therewith—the tag can have a unique value assigned and associated to that particular card, and can include access to stored user health information—e.g., public or emergency information/summary.

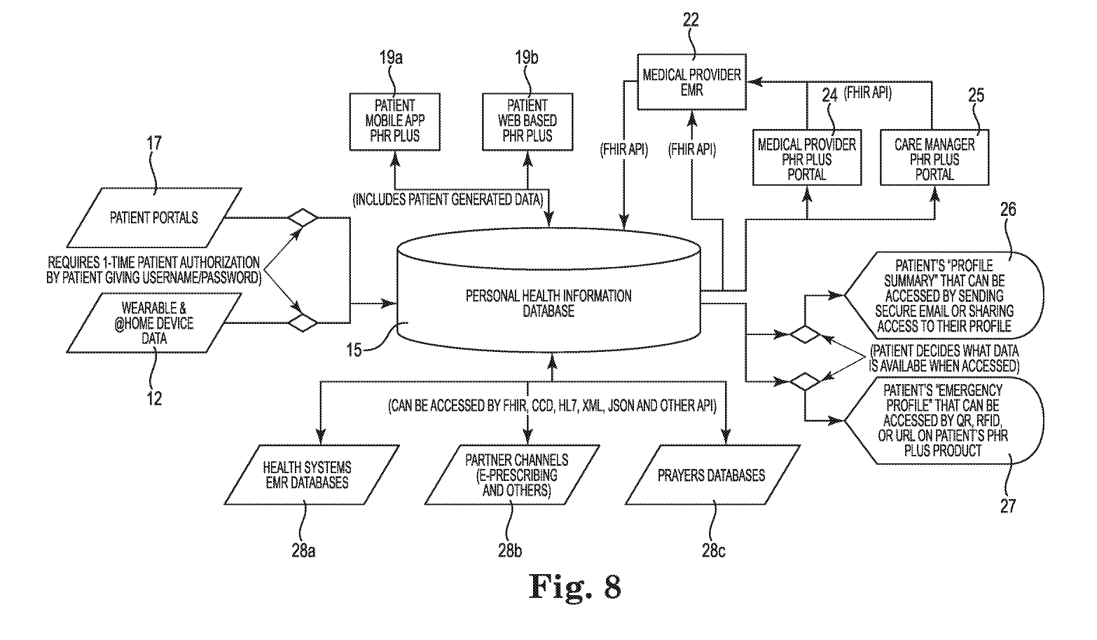

FIG. 8 depicts hardware and software connectivity and communication of the system 10 between the personal health information database 15 and the user and healthcare professionals and systems. The patient or user portal 17 and device 12 data can be transferred to and stored in the database 15. Further, the user's health data can be read from, edited, and stored within the database 15 via various methods, including mobile 19a and web-based 19b interfaces. Medical provider software and interface 22 (e.g., EMR—electronic medical records) can link medical provider portals 24 and care manager portals 25 to the database 15. As detailed herein, the user patient's health information can be made available to healthcare personnel via access to and displaying of the user's profile summary 26 (via sharing access permissions) or the user's emergency or public profile 27 (via QR code, RFID, NFC, or URL access to the data). In addition, external health systems, such as EMR databases 28a, partner channels 28b (e-prescribing and like systems), and payer systems 28c can communicate applicable data and information to the database 15.

Access to a user's public or emergency health information can be conducted via any device 12 by scanning the unique QR code on the user's card device, scanning of the unique RFID or NFC tag, via web application communication, via biometric authentication and communication initiation on a device 12 (e.g., smartphone, smartwatch, laptop, or tablet), via inputting of a user PIN and ID number, an application that launches a URL with the user's PIN & ID number, and a myriad of other security, login, and data communication methods and techniques.

Each device 12 can include a Globally Unique Identifier (“GUID”) that is automatically interrogated by the system 10 upon initiation or use. If the device is not registered with the centralized health record system (e.g., the central data hub 18 or database 15), the user will be queried if they wish to have their data synced with the system. If the user inputs an affirmative response, registration inputs will be displayed for the user to complete. Thereafter, the user device 12 and its associated health care data will be automatically synced to the central data hub when internet access is present, or upon periodic polling and updating of a device 12 by the system 10.

Further, the system 10 of the present invention can automatically sync data to the device 12 from third party medical devices (e.g., glucometers, blood pressure monitors, SPO2 sensors, thermometers, etc.), activity trackers (Fitbit, Jawbone, iHealth etc.), and health related software applications (Runkeeper, MapMyFitness, Apple's Activity, MyFitnessPal, etc.) running on the user device 12, or other devices, via various communication platforms and interfaces, including APIs, wired or wireless connectivity (e.g., Wi-Fi, wireless, Bluetooth, etc.), and the like. This data is synchronized to a user's personal health record database upon the user's authorization. The user selects a device or application that they want to sync to the PHR+ hub, can then input their username and password to the PHR+ application for the corresponding third party manufacturer's application (e.g., web app, mobile app, etc.). Data is then displayed within a user dashboard interface of the system 10 to give them an accurate insight, summary, and details of their medical data and conditions. The user's PHR+ dashboard and other system 10 software features can interact and communicate with as many devices and health-related apps as the user elects and inputs. Further, the user can selectively disassociate a device or third party application from their personal health record dashboard. Users can view their corresponding dashboard data on a web application, mobile applications, USB application, and the like. Additionally, as detailed herein, the data can be displayed or retrieved via a public profile on a USB device, by scanning RFID or NFC devices or components, or via the scanning of QR codes. The user has the ability to decide and select what devices, apps, or personal health information is viewable in the public profile and what information is password protected in privacy settings. The user can elect and input which device and corresponding health data they want to share with others—e.g., make displayable and accessible to other users or healthcare professionals.

For those embodiments of the user device 12 not including a display and/or input options, the device 12 can be configured to interact with one or more computing devices 16—e.g., a desktop computer, a laptop computer, a tablet, etc. As such, the interaction (e.g., via plugging at least a portion of the device 12 into a USB port of a computing device, or otherwise scanning/reading the device 12) can serve to execute the health record maintenance software 14 so that the user can enter and edit pertinent personal health care data, as detailed further herein.

In certain embodiments the program or software is a “web app,” such as an HTML5 app. For instance, the user device 12 can include a website interface to permit a user to input data, view data, and interact with the servers and services. Alternatively, the user device 12 can include a standalone “app” to permit the user to input data, view data, edit and modify data, and interact with the servers, services, and databases described herein.

Exemplary servers of the present invention, such as one or more servers of the central hub 18 and database 15, are configured to generate, maintain, and host computer program products in various embodiments. The servers generate, maintain and host web pages (e.g., HTML documents) that embody the present invention. The servers can include services associated with rendering dynamic web pages, such as data storage services and databases, security services, etc. Accordingly, the servers can include a conventional hardware arrangement and can be outfitted with software and/or firmware for performing web server functions for performing aspects of, and processing data associated with, the present invention, such as, for example, javascript/jquery, HTML5, CSS2/3, and facilities for SSL, MySQL, PHP, SOAP, Caché, etc.

The servers may be coupled with a data storage facility, which may include one or more local or remote memory systems or units, and can include one or more databases and/or file systems for storing data, media, graphics, HTML documents, XML documents, etc.

The servers can be configured to include admin functionality, which enables an administrator to perform system-related functions. The system-related functions can include maintaining user records, interacting with third party services and servers, performing upgrades on the software, and facilitating the exemplary certification or verification services disclosed herein.

Certain user devices 12 (e.g., mobile devices or smartwatches) can include a processor, which may include one or more microprocessors and/or one or more circuits, such as an application specific integrated circuit (ASIC), field-programmable gate arrays (FPGAs), etc. Further, the devices 12 may include a network interface. The network interface is configured to enable communication with a communication network 13 and servers, using a wired and/or wireless connection. The devices 12, at the processor, or separate therefrom, can include memory, such as non-transitive, which may include one or more non-volatile storage devices and/or one or more volatile storage devices (e.g., random access memory (RAM)). In instances where the devices 12 include a microprocessor, computer readable program code may be stored in a computer readable medium or memory, such as, but not limited to magnetic media (e.g., a hard disk), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described herein. In other embodiments, the device is configured to perform steps described herein without the need for code.

It will be recognized by one skilled in the art that operations, algorithms, logic, method steps, routines, sub-routines, and modules may be implemented in software, in firmware, in special purpose digital logic, and any combination thereof without deviating from the spirit and scope of the present invention as recited within the claims attached hereto.

The devices 12 can include an input device configured to receive an input from either a user, or a hardware or software component. Examples of an input device include a keyboard, microphone, touch screen and software enabling interaction with a touch screen, etc. The devices 12 can also include an output or display device. Examples of output devices include monitors, mobile device screens, tablet screens, speakers, remote screens, etc. The output device can be configured to display images, media files, text, or video, or play audio to a user through speaker output.

In addition to the specific devices 12 described herein, other compatible and integrated or operably connected to devices 12 can include hardware and software provided by Adidas, Apple, AsthmaMD, Bewell Connect, Biometrics, BodyMedia, CareTRx, DailyMile, Epson, Fitbit, Fitbug, FitLinxx, Garmin, iHealth, Jawbone, Life Fitness, MapMyFitness, Microsoft, Nike, Omron, Sony, Suunto, VitaDock, VitalUP, Withings, etc. Viable data that can be synced, processed, and used by the system 10 from such devices 12 can include: activity tracking (e.g., steps, distance, time, calorie burn, etc.), blood pressure, body temperature, pulse, lung capacity, heart rate, blood glucose levels, nutritional information, weight, BMI, exercise information, prescription compliance and information, light exposure information, sleeping information, and the like.

This vast user health data is synchronized to a user's personal health record 15 upon their authorization. Data is then displayed within the user's dashboard or similar interface to give them an accurate insight into and information regarding their medical conditions and data.

The PHR+ software 14 of the present invention permits a user to create PHR+ profiles for loved ones and share their PHR+ profile information with anyone they choose. This feature allows family members and caretakers to either create, edit, or monitor other user's PHR+ profiles if they have been authorized to do so. This function provides the ability to monitor loved ones/patients remotely, improves care coordination, and can reduce medical errors during treatment or times of medical emergency. There are at least two scenarios in which a user can gain access to another user's profile.

Scenario 1: User A can set up a PHR+ personal health record profile for User B. In order to create User B's profile User A must have the legal authority to create a profile for User B. In the case where User B is a minor or does not have the mental capacity to create a profile, User A will need to upload proper documentation or data to prove that they have the authority to create a profile on User B's behalf. In the event User B has the mental capacity to make their own medical decisions, they will have to create a profile and grant User A access to their profile as outlined in Scenario 2 below.

Scenario 2: User A can gain access to User B's PHR+ personal health record profile that has already been created if User B authorizes User A to have access. Any user can share part or all of their profile with another user via an input selection of the “Share” function. A user can permit others to edit their PHR+ information, or permit others read-only access via a specific input selection. For example, User B may allow User A the ability to add or edit their entire PHR+ profile, and they may also allow their nurse or other healthcare professional read-only access to their medical profile—but no access to their device data. User B may also allow User C to view a limited part of their profile, such as medications via a corresponding input selection. The PHR+ software makes selective permissions and sharing medical information core to the PHR+ personal health record, and the sharing functionality is as granular as the user decides—selecting exactly what information or data is sharable.

As result of the shared access functionality of the system 10, the PHR+ facilitates population health management for medical providers, health & wellness companies, employers, insurers, and other large organizations. Because a user can permit others to have access to their information and data, this functionality and medical data can be used to assist with population health.

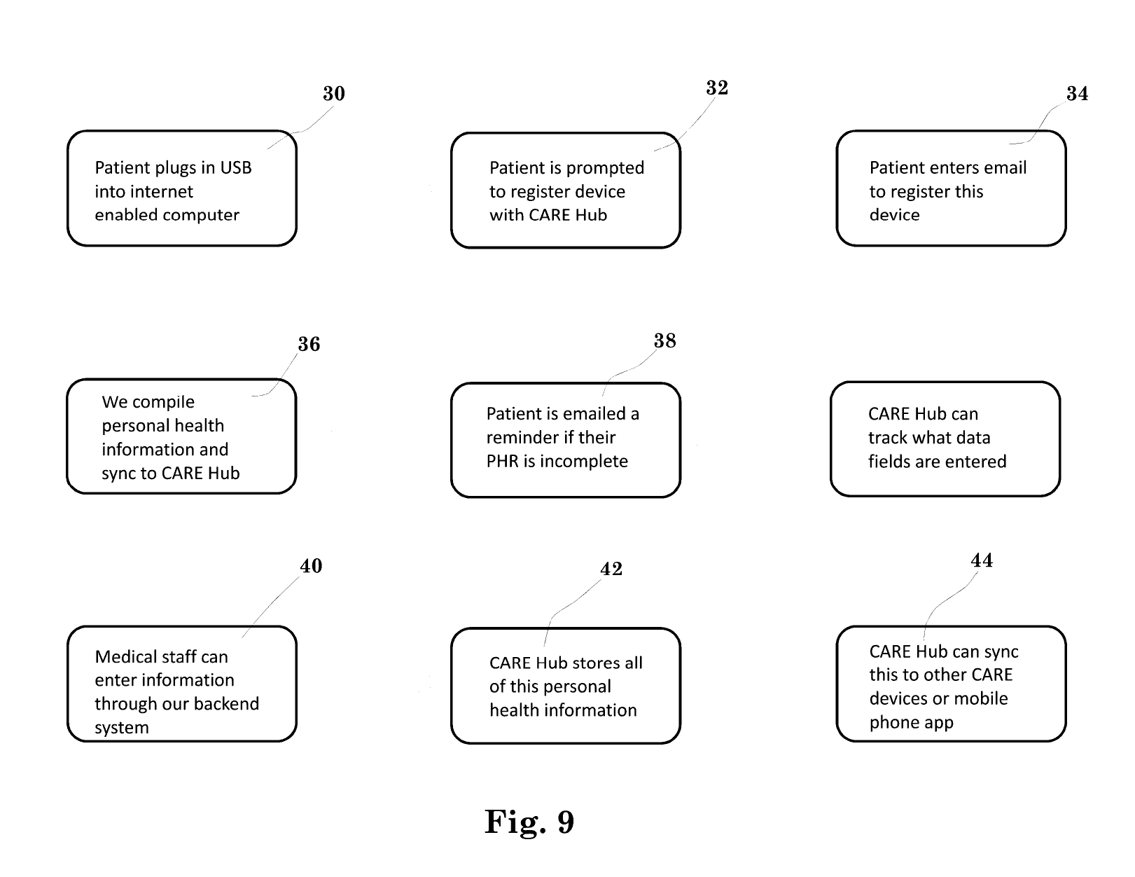

FIG. 9 depicts a flow diagram of a step-by-step method step for general operation and use for embodiments of the present invention. First, for those embodiments including a USB device 12, the user plugs in the USB portion of the device 12 into a computing device 16 at step 30—e.g., an internet-enabled computing device. As a result of this USB docking, the record software 14 can be automatically executed or initiated. At this point, the user is prompted at step 32 to register the device with the records hub 18/database 15, if reading of the GUID of the device 12 indicates that registration has not yet occurred. Registration can include entering a valid email address (step 34). At step 36, the hub software or server 18 generates and sends an email—indicating the need to complete the PHR data, update the PHR data, etc. The data entered by the user in the health record software 14 can be compiled at the hub 18 and database 15 for that particular user (and encrypted/secured) for syncing across one or more user devices 12 (step 38). Further, additional user medical information can be entered by medical professionals via the hub 18 or other interconnected medical devices or portals at step 40. The combination of the user-entered data and the data entered by medical personnel is processed and stored as the user's complete health record in the health information database 15 at step 42. Again, the compiled and complete record can be synced to one or more of the user's devices 12 (wearable, smartphone, etc.) at step 44. While a USB device is identified in the diagram, the same use process can be included with other devices 12 via wired or wireless communication protocols.

In various embodiments of the present invention, the PHR+ software can be viewed on any computing device, requiring no internet access, such that medical staff is not required to download any software to view the user's medical information. All necessary data and software code can be contained or stored on the user device—whether automatically displayed on a medical professional's device or viewed/retrieved from the user device itself (e.g., smartwatch, smartphone, wearable, ID card, etc.). Accordingly, the best and most detailed information can be presented to the medical professional at the point of care, and instantly.

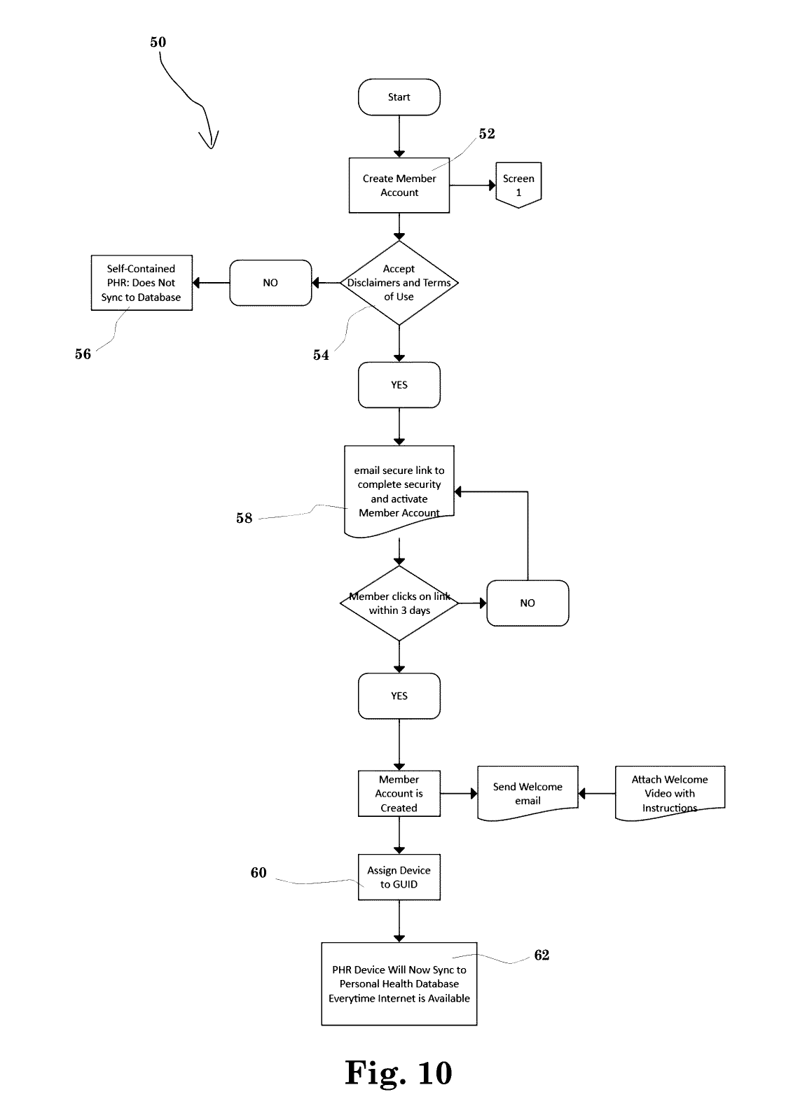

Registration and initial use 50 of the system of the present invention is shown in the flow diagram of FIG. 10. As stated herein, insertion or initial use of the device 12 or software 14 can initiate a member or user creation step 52. Terms of use and other privacy/use information can be displayed to the user at step 54. The user can choose not to have their health records and information sent to and synchronized with the health record hub 18/database 15. If not, that device 12 can function as a standalone, self-contained, device which will still be updated and maintained by the user for use by medical personnel (step 56). If the user does select the option of having the health record data compiled and accessed at the hub 18, the referenced notification and other verification steps can be performed at step 58. From there, the device 12 is assigned the GUID (step 60) and is capable of automatically syncing to the personal health database 15 at the hub 18 (step 62).

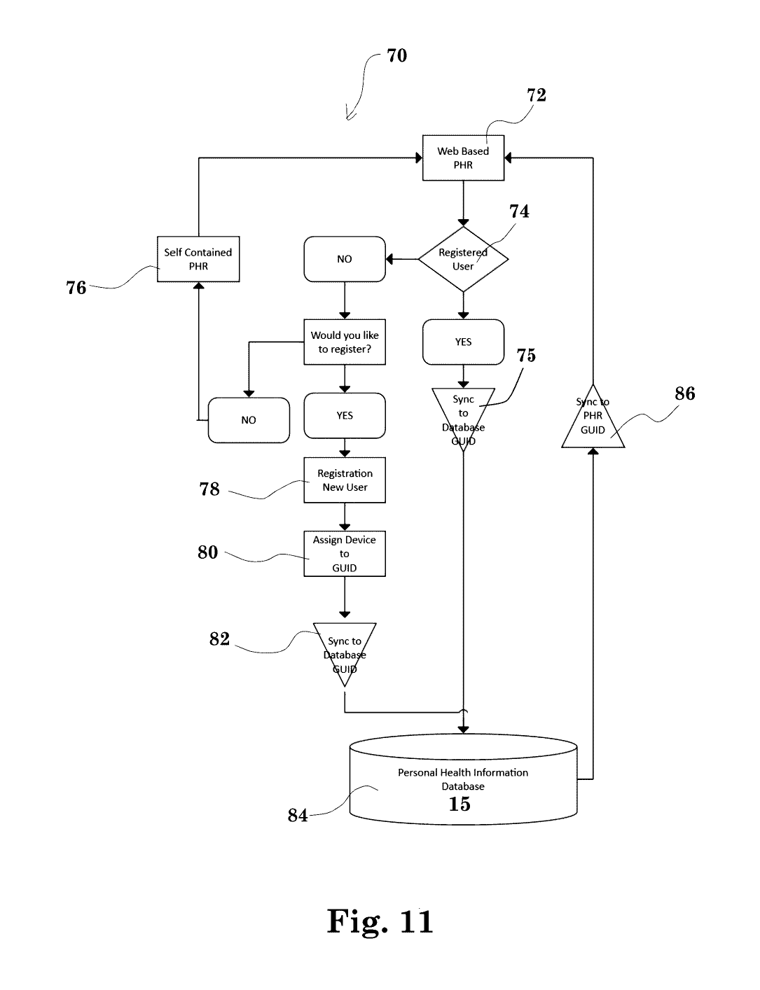

FIGS. 11-13 show flow diagrams for web-based, USB-based, and mobile-based personal record registration and use 70, respectively. At a login or like screen, a user can enter the personal record system. As such, registration options are displayed for the user at steps 74-80. The user can login if they are already registered. If not, the user can input registration information to link the user data and personal health record information with the system 10 so that a protected database 15 is configured for syncing across one or more devices (step 98). If the user does not wish to register, use of the system and access to the user's personal health information is isolated at step 76 to the user's device and not saved and synced across the centralized database 15—e.g., provided as a self-contained PHR. Again, this process of registration and use is available across a plurality of platforms and devices (e.g., web-based, USB wearable or device, mobile app, ID card, etc.). Syncing can be associated with the database 15 in accordance with the device GUID (steps 84-86).

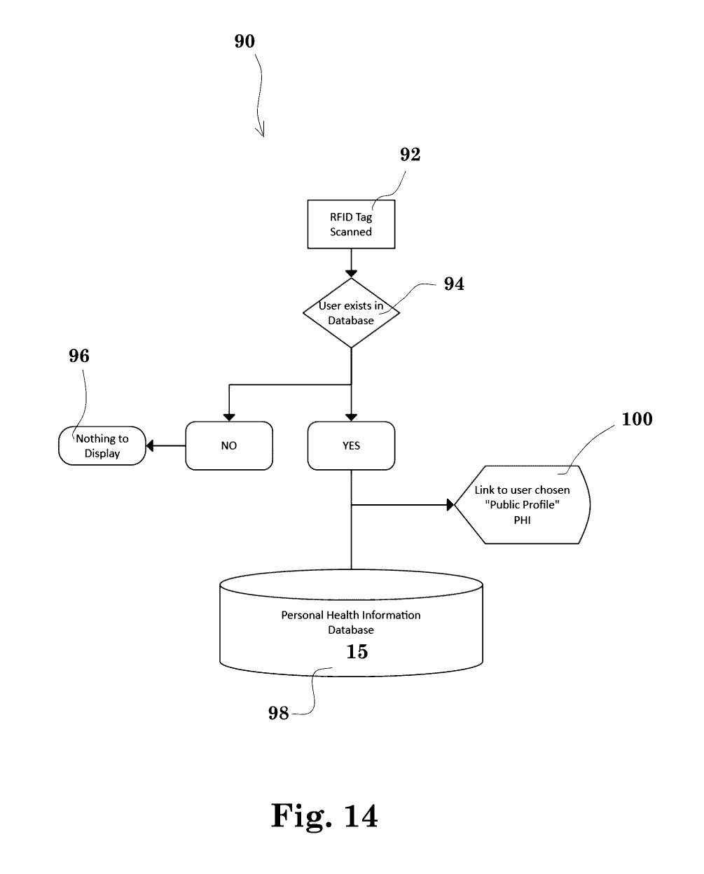

FIGS. 14-16 depict use diagrams for electronically receiving and/or processing 90 the user's personal health information. Namely, physicians, health professional staff, and the like, can scan or otherwise read data from the user device, as shown at steps 92-100. This can occur via RFID tags, QR codes, NFC tags, wireless or wired data transfer, etc. The scanned (or otherwise linked/readable) data can initially be processed to determine if the user exists in a database at step 94. If the user does exist, access to that user's health information in the database 15 (step 98) is readable for displaying, viewing, and processing. As shown at step 100 and described herein, a predefined portion of the user's data can be designated as “public” and made correspondingly available. Other personal or private health data for the user can require a password known or provided by the user.

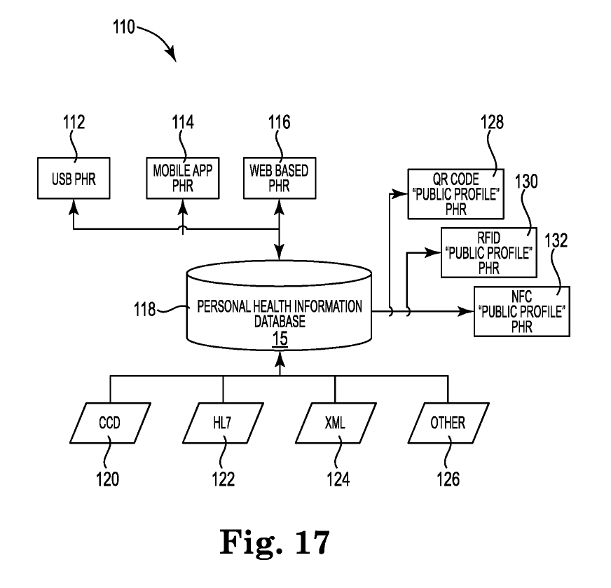

FIG. 17 provides a diagram of an embodiment of the system 10 at process 110, including user input to and maintenance of the individual's health record, and the interconnectivity between the user and medical professionals—steps 110-132. At steps 112-116, the user's PHR (via USB, mobile, web, etc.) are in operable communication with the system's personal health information database 15 for reading, scanning and/or processing by a medical health professional at steps 128-132 (via QR code, RFID, NFC, etc.). Data and information can be inputted or otherwise provided to the database 15 as well at steps 120-126 (e.g., via CCD, HL7, XML, or other data/information standards).

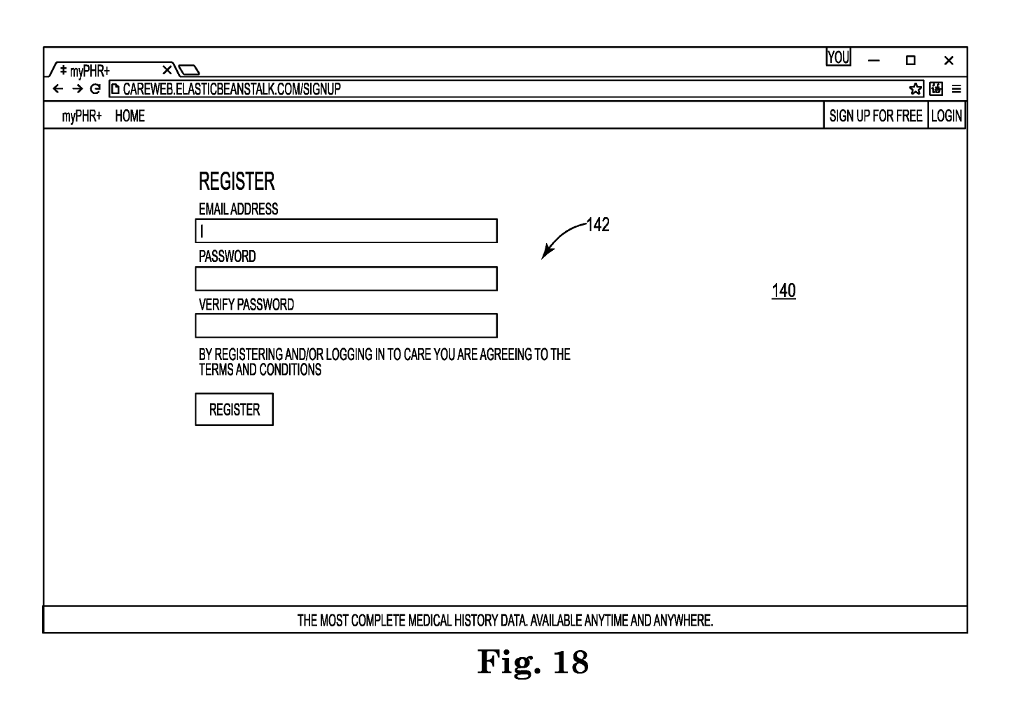

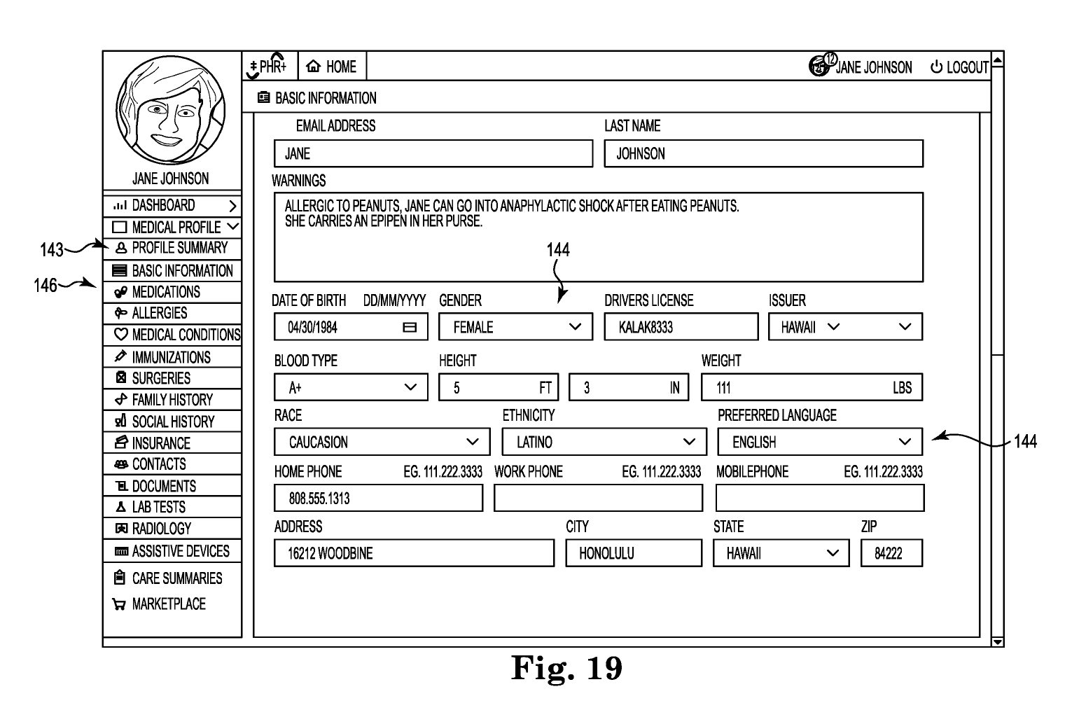

FIGS. 18-30 provide exemplary screenshots of the system 10 software—e.g., interface and data input regions for the user (on one or more user devices) or the medical professional/provider. FIG. 18 is a screenshot of a registration screen 140 designated for input by the user in accordance with embodiments of the present invention. Email address, password, username, and other information 142 can be inputted and stored to set up an account for a new user. FIG. 19 shows a screenshot of a user interface on a user device—e.g., web-based or desktop software implementation. Column 146 can include selectable categories adapted for receiving and storing information inputted by the user. Basic information, including medications, allergies, medical conditions, family history, surgeries, social history, etc. can define various categories or tabs 143. Each category can include a subset of data fields 144 adapted to receive corresponding data input from the user. For “basic information” (FIG. 19), the user's name, warnings, date of birth, gender, blood type, contact information, and like data can be entered in the fields and stored in the referenced centralized database 15 (or as a standalone database on the user device).

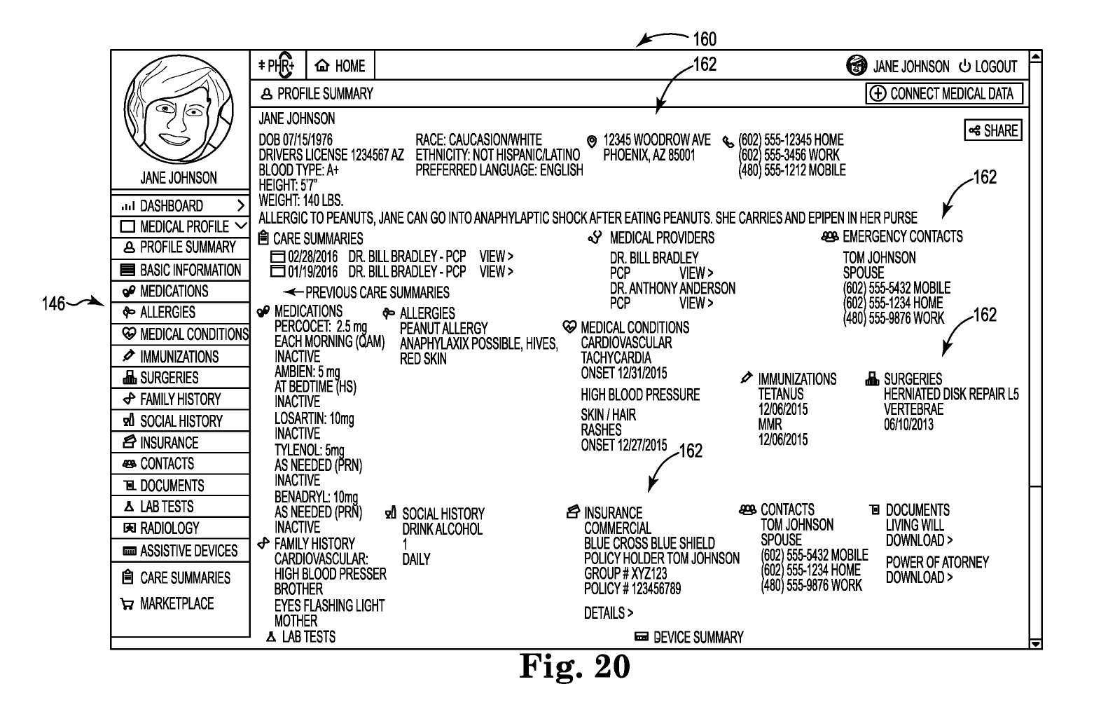

FIG. 20 shows a user profile summary 160, including the health data fields 162 entered and stored in the database 15. A user or other authorized person or system can select a particular data field in the profile summary for editing that portion of the data record. This profile summary can include data on the user's personal biographical information (DOB, contact information, age, weight, etc.), past and present medications, medical providers, emergency contact information, allergies, medical conditions, immunizations, past surgeries, family history, social history, insurance information, contact information, important health/medical documentation (e.g., living will, power of attorney, DNR, etc.), information on engaged devices 12 linked to the system 10 for that user, and the like.

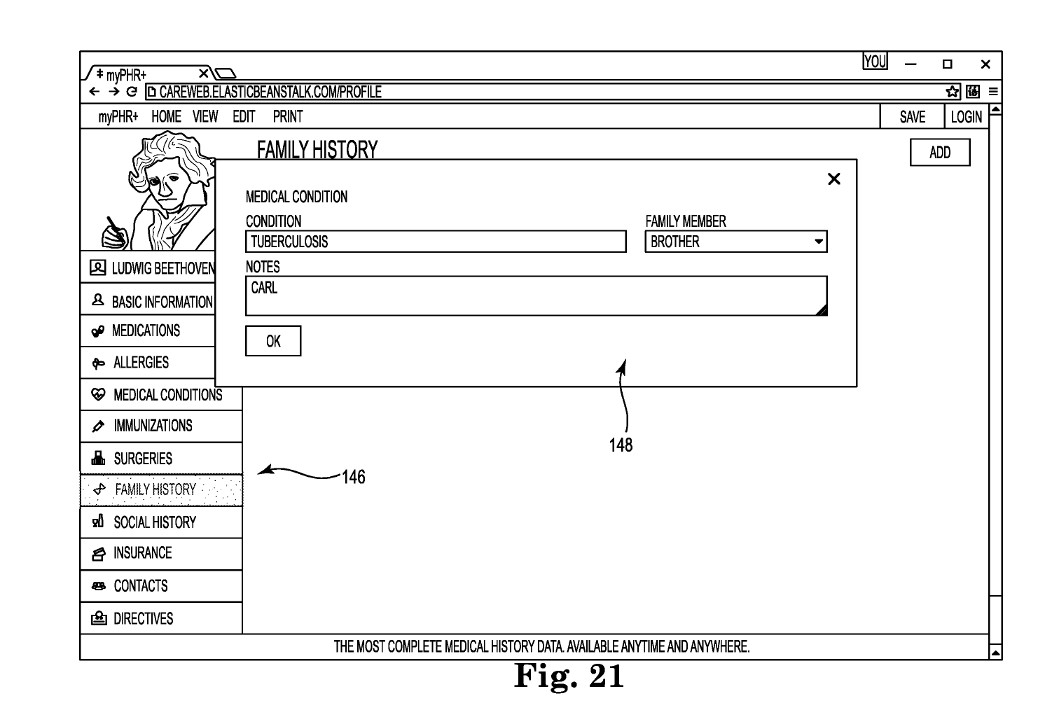

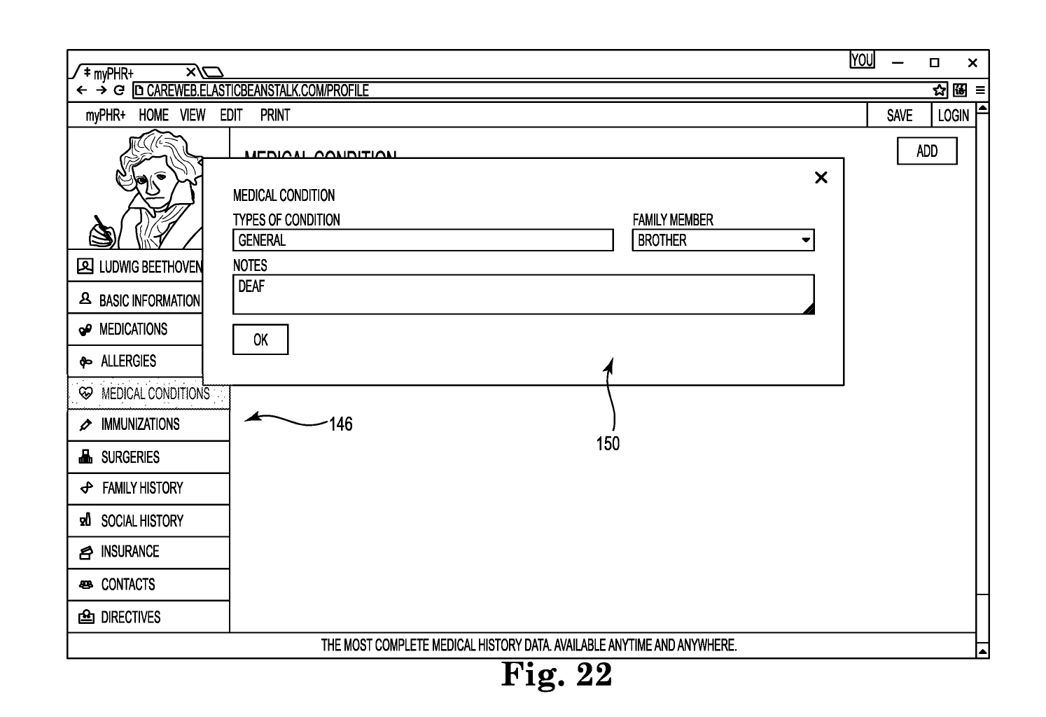

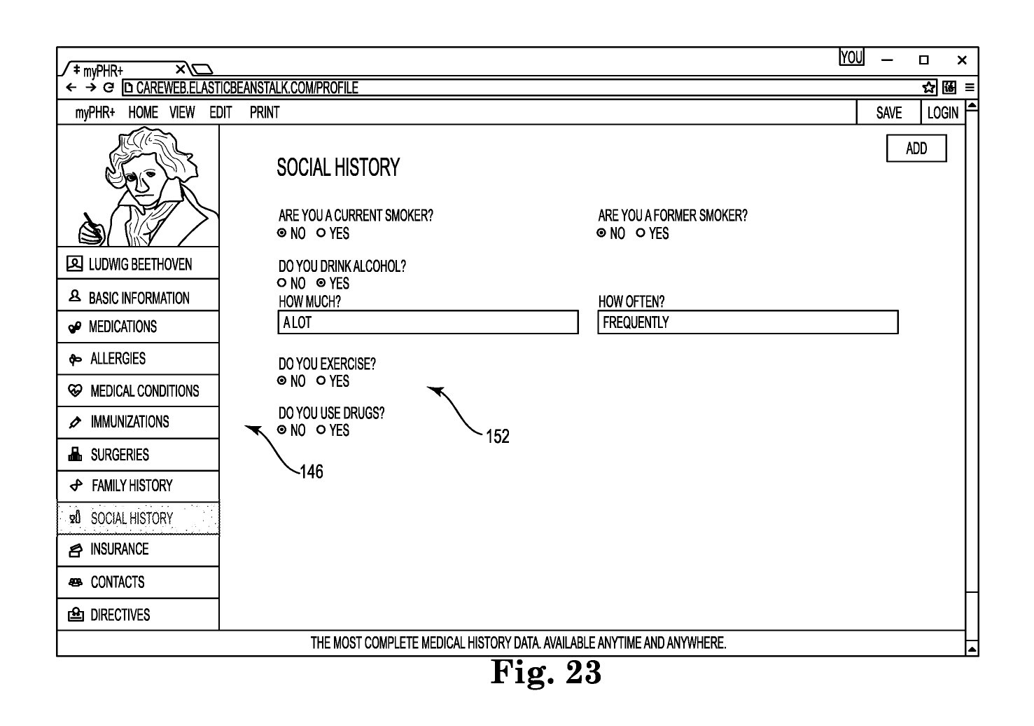

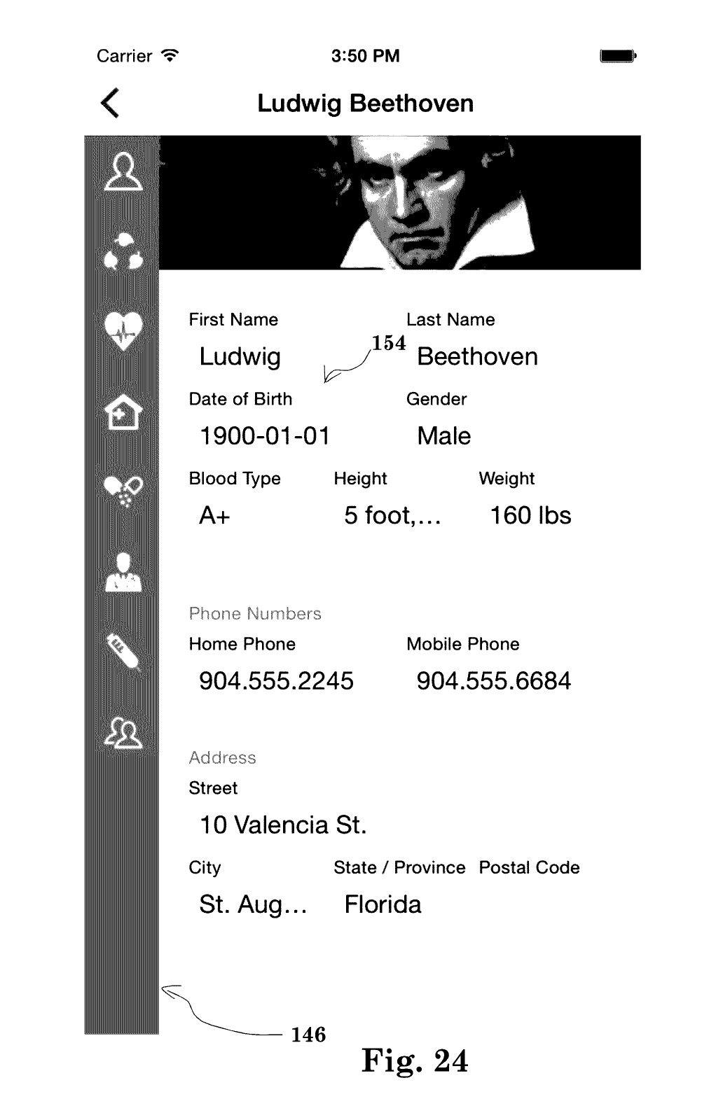

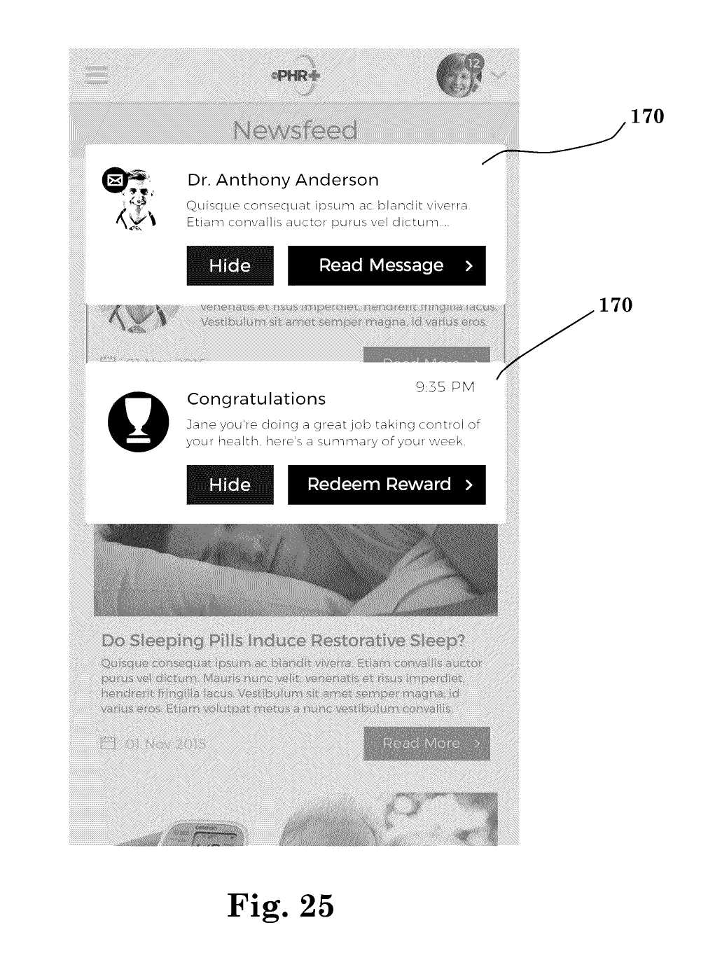

FIG. 21 shows the enterable data fields 148 for the “family history” category, FIG. 22 shows the data fields 150 for the “medical condition” category, and FIG. 23 depicts the data fields 152 for the “social history” category. Again, a wide variety of categories and data/information within each category can be displayed, and can be editable, to provide a vast array of information for the user's personal health record. FIG. 24 is an exemplary screenshot from a mobile app running on a mobile user device (e.g., smartphone or tablet). Again, the plurality of categories 146 can be displayed and are selectable by the user for viewing and inputting data in the various sub-fields 154.

FIG. 25 shows a patient engagement screen, wherein the medical provider can provide notices and send messages for the patient to receive at their respective computing system or device. The messages and notifications 170 can be displayed on the user's screen via distinct dialog boxes, thereby permitting interaction by the user (e.g., to hide the message, read the message, redeem rewards based on patient compliance, etc.).

This engagement sequence can include a series of emails, SMS, or other known communication methods and techniques, based on the medical provider's workflow set up within the PHR+. For example, Patient A may have blood pressure readings that

Medical Provider B thinks are too high. Medical Provider B can send Patient A a series of engagement coaching messages to take action. The PHR+ medical provider portal processes and outputs a notification to the provider, patient, or someone else specified based on the value of the data. In another example, Patient D may have blood sugar levels that are trending up over a one-week period. This information is stored for the user and the system 10 can process and notify the medical provider and output a message or notification to the patient to take action. The PHR+ medical provider portal dashboard will therefore show biometric data based on trends and this data can be displayed as color coded information depending on the data values. Of course, a medical provider can also view an individual patient's medical information, such as medications, past treatments or procedures, allergies, etc. that the patient has permitted the provider to view.

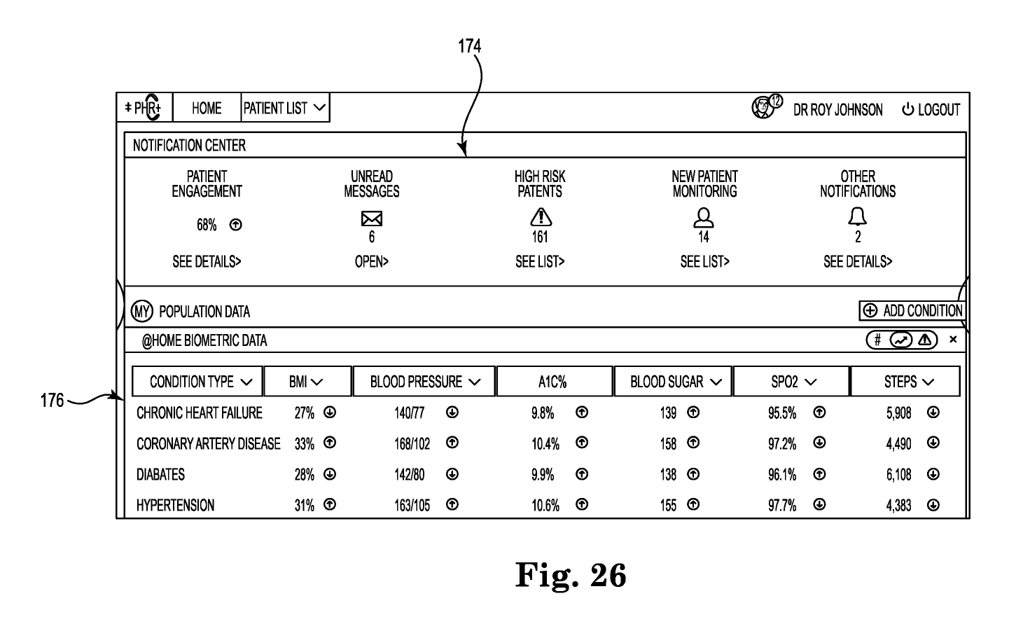

Referring to FIG. 26-30, screenshots of the medical/healthcare provider software interaction options and details are shown. FIG. 26 includes a summary patient screen, that can include a notification center 174 (displaying, for instance, details or summaries on patient engagement, unread patient messages, high risk patient statistics, new patient monitoring data, etc.) and a population data section 176 (displaying, for instance, biometric data for a plurality of patients in a summary or detailed statistical format). Other patient and population data and information can be detailed or summarized for the medical professionals.

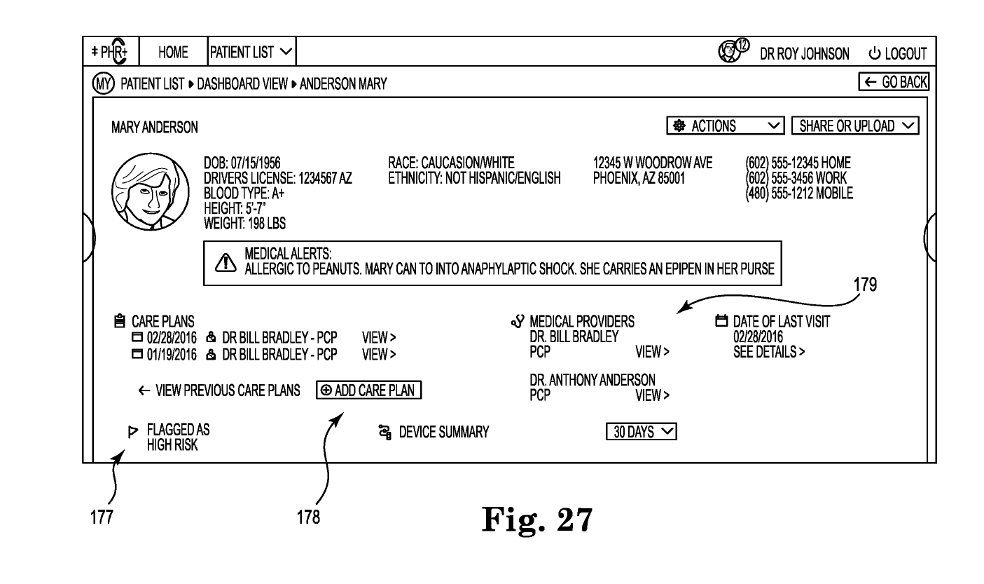

FIG. 27 shows a medical provider dashboard or portal screen for receiving inputs and displaying selected information for a patient. The medical provider dashboard can display a list of each patient's biometric data. From this dashboard a medical provider can flag high risk patients 177, send the patient a message, assign or review patient care plans 178, review displayed visit and provider information 179, and the like.

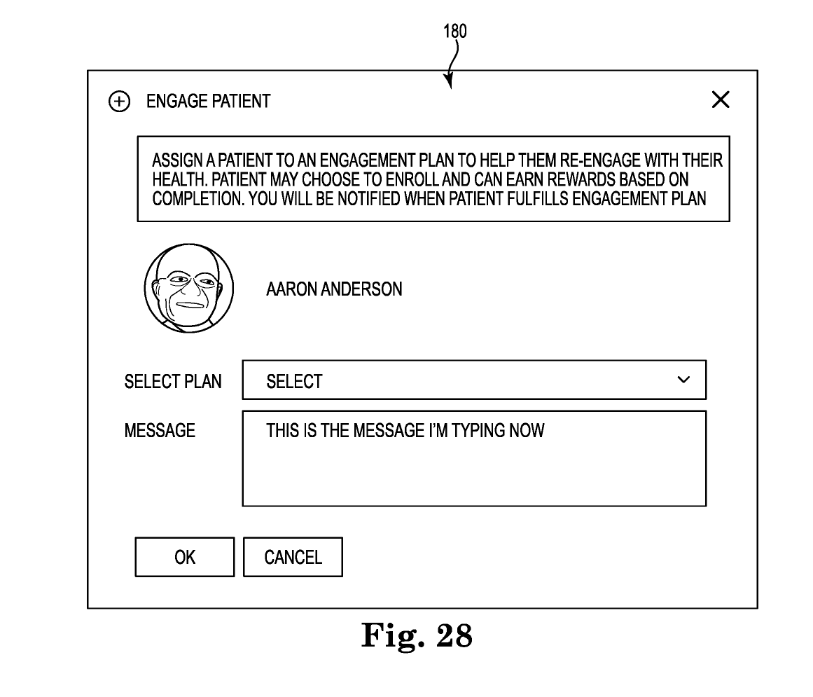

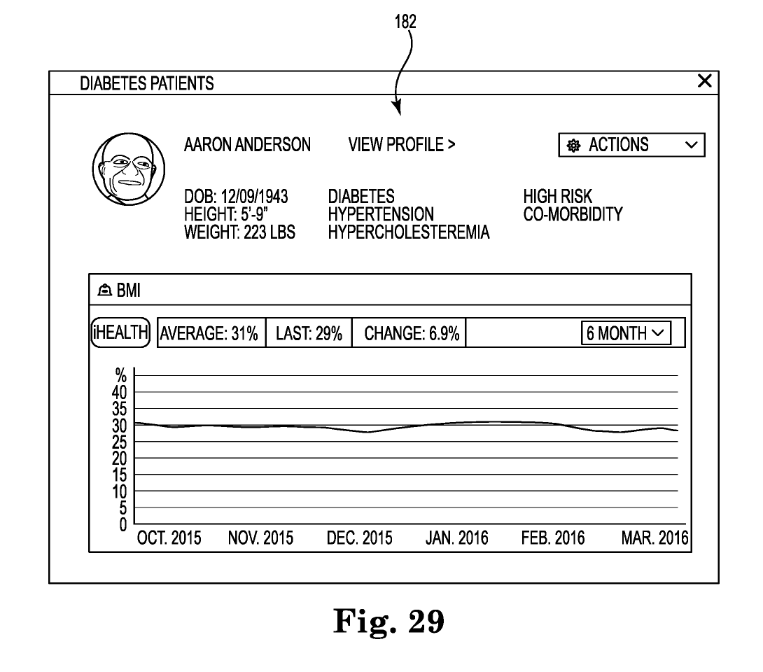

FIG. 28 shows a patient engagement dialogue window 180 for inputting information by the provider such that a message with text and other displayed information is sent and displayed to the patient at a computing system or device. FIG. 29 depicts a patient summary page 182 related to a specific medical condition or treatment plan. This screen can display a patient's biometric and statistical data relating to diabetes or other disorders or conditions, including graphical and textual data detailing the patient's condition relative to other like-categorized patients.

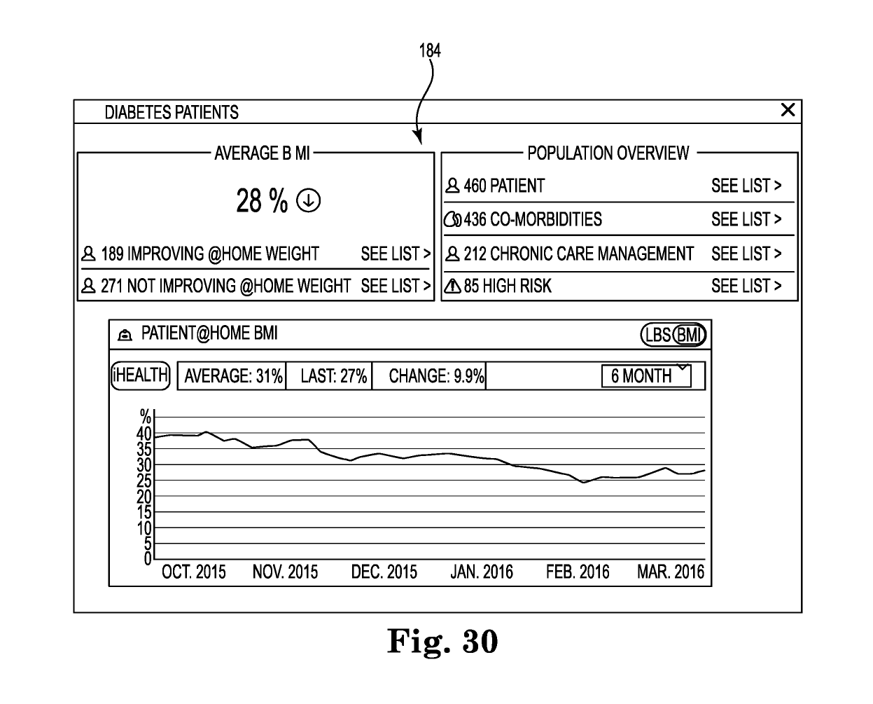

Again, the system 10 can include a PHR+ medical provider portal that permits a doctor or other healthcare provider to view a home dashboard where they can view their numerous patients' biometric and medical data, once they have been granted access from the patients' PHR+ record and devices—e.g., based on medical condition type. The medical provider can view more detailed information for a data type such as blood pressure, blood sugar, weight, and other information for the population associated to that condition. For example, Medical Provider A may want to monitor COPD, Diabetes, and Hypertension patients separately on their home dashboard. Medical Provider A can see that biometric displayed at a high level overview, and they can also see more detailed information displayed about a single data type for a single condition as desired. In another example, Medical Provider A can select BMI for diabetes patients and view the displayed results 184 showing the number of patients associated, how the data is trending, and aggregated averages for their diabetes' BMI (e.g., FIG. 30). While diabetes data is disclosed as an exemplary study, this granular processing and displaying of data and results can apply to all medical conditions, disorders, or treatments—across all patients for which the medical provider is linked via the system 10.

The system 10 can facilitate population health to employers, insurance providers, and large organizations based on their users' biometric data such as steps, distance, calories burned, floors climbed, active minutes, inactive minutes, workouts logged, blood pressure, blood sugar, weight, BMI, SPO2, and heart rate. These organizations can monitor their users' data at an identified population level. They can view the percentage of their population that has biometric data trending up, remaining constant, or trending down. For example, an organization can login to a PHR+ population health dashboard or software and view that 50% of their users are improving their daily steps, 30% are remaining constant, and 20% are trending down. This same tool can trigger (automatically or manually by the organization) emails, SMS, and other messages based on the individual's performance. Below are two exemplary models for this monitoring and notification feature.

### Example 1

User A has been improving their daily active minutes for 4 days in a row and accordingly they will receive an automated congratulatory message from their participating organization. PHR+ also processes and allows organizations using the health dashboard to create challenges and set rewards to users based on their biometric data.

### Example 2

An employer can set up a challenge within the PHR+ health dashboard for most steps in a given week, send out a notification of the challenge to tagged patients, and at the end of the week a user with the most steps can be rewarded a prize.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the methods described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A portable health record system, comprising:
one or more user devices each including inputted personal health data;
a health record data hub selectively in operable communication with the one or more user devices; and
a healthcare professional communication portal selectively in operable communication with the health record data hub.

2. The system of claim 1, wherein the one or more user devices include a wearable device.

3. The system of claim 1, wherein the one or more user devices includes a mobile computing device.

4. The system of claim 1, wherein the one or more user devices include an electronically readable user card.

5. The system of claim 4, wherein the electronically readable user card includes a QR code.

6. The system of claim 4, wherein the electronically readable user card includes an RFID device.

7. The system of claim 4, wherein the electronically readable user card includes an NFC device.

8. The system of claim 1, further including a user health data communication portal in operable communication with at least the health care data hub.

9. The system of claim 1, wherein the one or more user devices are adapted to communicate or display health record data flagged by a user as private or public.

10. The system of claim 1, wherein the inputted personal health data is selected from a group consisting of: user's name, user's gender, user's date of birth, user's blood type, user's blood pressure, user's blood sugar, user's allergies, user's medication, user's medical conditions, user's social history, user's medical history, and user's family medical history.

11. A portable health record system, comprising:
one or more user devices each including inputted personal health data and adapted to selectively display as an output;
a healthcare professional communication portal in selectively operable communication with the health record data hub.

12. The system of claim 11, wherein the one or more user devices include a wearable device.

13. The system of claim 11, wherein the one or more user devices include an electronically readable user card.

14. The system of claim 11, wherein the one or more user devices are adapted to selectively display as an output health record data flagged by a user as private or public.

15. The system of claim 11, wherein the inputted personal health data is selected from a group consisting of: user's name, user's gender, user's date of birth, user's blood type, user's blood pressure, user's blood sugar, user's allergies, user's medication, user's medical conditions, user's social history, and user's family history.

16. A method of storing and providing personal health data, comprising:
providing one or more user devices each including inputted personal health data;
providing a health record data hub selectively in operable communication with the one or more user devices; and
providing a healthcare professional communication portal selectively in operable communication with the health record data hub.
